(19) United States
(12) Patent Application Publication
(10) Pub. No.: US 2008/0070068 A1
(43) Pub. Date: Mar. 20, 2008

(54) Fuel cell stack

(75) Inventors: Wolfgang Fritz, Metzingen (DE); Uwe Maier, Reutlingen (DE)

Correspondence Address: Mr. Edward J. Timmer, P.O. Box 770, Richland, MI, 49083-0770, US

(73) Assignee: ElringKlinger AG

(21) Appl. No.: 11/800,143

(22) Filed: May 4, 2007

(30) Foreign Application Priority Data
Jun. 21, 2006 (DE) 10 2006 028 498.4

(51) Int. Cl. H01M 8/02

(52) U.S. Cl. 429/12

(57) ABSTRACT

In order to provide a fuel cell stack, comprising a plurality of fuel cell units that succeed one another along a stack direction and at least one tensioning device, by means of which the fuel cell units are braced against one another, in which different heat expansions of the fuel cell units, on the one hand, and of the at least one tensioning element, on the other hand, are compensated and which is nevertheless simply constructed and easy and quick to fit, it is proposed that the tensioning device comprises at least one tensioning element, which transmits a tensile force for tensioning the fuel cell units, and at least one resilient longitudinal expansion compensation element, which is integrated in a tensioning element or in a fastening device connecting two tensioning elements to one another.

The present disclosure relates to the subject matter which has been disclosed in the German patent application number 10 2006 028 498.4 dated 21^{st} Jun. 2006. The entire description of this earlier application is incorporated by reference in the present description (“incorporation by reference”).

The present invention relates to a fuel cell stack, which comprises a plurality of fuel cell units that succeed one another along a stack direction and at least one tensioning device, by means of which the fuel cell units are braced against one another.

A fuel cell stack of this type is known, for example, from DE 100 44 703 A1.

In the case of known fuel cell stacks of this type, the tensioning device comprises a plurality of tie rods, by means of which solid end plates of the fuel cell stack are drawn against one another in order to apply the sealing and contact forces required during operation of the fuel cell stack on the fuel cell units.

It is known from DE 10 2004 037 678 A1 to design the tensioning elements, by means of which the end plates of a fuel cell stack are braced against one another, as a rod, rope, wire, chain, band or fibre material and to arrange spring elements between the tensioning elements and the end plates in order to be able to very finely adjust the pressure loading on the fuel cell units.

In the event of a temperature change, in particular during heating to the operating temperature of the fuel cell units, the fuel cell units, on the one hand, and the material of the tensioning elements, on the other hand, can expand to a different degree in the stack direction of the fuel cell stack because of different mean coefficients of heat expansion.

The present invention is based on the object of providing a fuel cell stack of the type mentioned at the outset, in which different heat expansions of the fuel cell units, on the one hand, and of the at least one tensioning element, on the other hand, are compensated and which is nevertheless simply constructed and easy and quick to fit.

This object is achieved according to the invention in a fuel cell stack with the features of the preamble of claim 1 in that the tensioning device comprises at least one tensioning element, which transmits a tensile force for the tensioning of the fuel cell units, and at least one resilient longitudinal expansion compensation element, which is integrated into a tensioning element or into a fastening device connecting two tensioning elements to one another.

The resilient longitudinal expansion compensation element provided according to the invention allows the different heat expansions of the fuel cell units, on the one hand, and of the material of the at least one tensioning element, on the other hand, to be compensated in the event of a temperature change of the fuel cell stack.

Since the longitudinal expansion compensation element is integrated into a tensioning element or into a fastening device connecting two tensioning elements to one another, the assembly of the longitudinal expansion compensation elements requires no adaptations of any type to the structure of the fuel cell units or the end plates of the fuel cell stack and also no assembly work on the fuel cell units or on the end plates of the fuel cell stack.

When the longitudinal expansion compensation element is integrated into a tensioning element of the tensioning device, the necessity of providing an additional component for the longitudinal expansion compensation is also dispensed with, so the number of components required for the construction of the fuel cell stack is reduced.

The tensioning element is preferably configured in this case in one piece with the longitudinal expansion compensation element.

In particular, it may be provided that at least one longitudinal expansion compensation element is formed by a corrugated and/or folded region of at least one tensioning element.

As an alternative or in addition to this, it may be provided that at least one longitudinal expansion compensation element is formed by a region, that is provided with a deformable recess, of at least one tensioning element.

When the at least one resilient longitudinal expansion compensation element is integrated into a fastening device connecting two tensioning elements with one another, a fastening device of this type may comprise at least one fastening means.

The fastening device preferably comprises at least two fastening means which are spaced apart from one another in a direction extending transversely to the stack direction.

In this case, the at least one fastening means can be configured as a fastening screw.

Furthermore, the fastening device may comprise at least one fastening strip, in which at least one fastening means engages.

Furthermore, the fastening device may comprise at least one receiving strip, through which at least one fastening means extends.

In a particularly preferred configuration of the invention, the fastening device also comprises at least one spring element, which biases an end region of at least one tensioning element against another end region of the same tensioning element or against an end region of another tensioning element. In this case, the spring element of the fastening device acts as a longitudinal expansion compensation element, which compensates a difference between the heat expansions of the fuel cell units, on the one hand, and the tensioning elements, on the other hand.

In a preferred configuration of the invention, at least one tensioning element of the tensioning device in the form of a strip or tape. A tensioning element in the form of a strip or tape has only a low weight and requires only little space. Such tensioning elements in the form of a strip or tape are also easy and quick to fit and economical to obtain.

It is also favourable if at least one tensioning element extends around at least one end face of the fuel cell stack. The tensioning forces can then be introduced from the tensioning element, distributed over a large area and uniformly over the relevant end face of the fuel cell stack, into the fuel cell units, so that a better force distribution is achieved than with tension means, which engage only on the edge of the end plates of the fuel cell stack.

The fuel cell stack according to the invention may comprise high temperature fuel cell units (for example of the SOFC (Solid Oxide Fuel Cell) type) or else low temperature fuel cell units (for example of the PEM (Polymer Electrolyte Membrane) type or of the DMFC (Direct Methanol Fuel Cell) type).

The tensioning device according to the invention is preferably used for applying the required sealing and contact forces during operation of the fuel cell stack, but can also be used only for securing for transportation (in the latter case, the tensioning device can be removed before the fuel cell stack is put into operation).

In a preferred configuration of the invention it is provided that the tensioning device comprises at least two tensioning elements, which extend around at least one end face of the fuel cell stack and are spaced apart from one another in a direction extending transversely to the stack direction.

The fuel cell stack may comprise at least one stack end element, which forms an end face limitation of the fuel cell stack.

A stack end element of this type may be configured, in particular, as an end plate.

At least one tensioning element preferably extends in this case around at least one stack end element of the fuel cell stack.

It is favourable in this case if at least one tensioning element rests, in particular substantially in a flat manner, on at least one stack end element, in order to ensure a good introduction of force from the tensioning element into the stack end element.

The tensioning element used is preferably flexibly configured, so it can fit closely against a stack end element of any design.

In order to put the tensioning element under tensile stress, it may be provided that the tensioning element is fixed to at least one stack end element.

In this case, the tensioning element may, for example, be fixed in cohesive manner and/or by means of at least one fastening means, in particular by means of at least one screw, to the stack end element.

It is favourable for a simple disassembly of the fuel cell stack for repair and maintenance purposes, if the tensioning element is fixed to at least one stack end element in releasable manner.

Particularly simply, in particular without the use of additional fastening means and without an additional tool, the fixing of the tensioning element on the stack end element can be implemented if the tensioning element is hooked onto the stack end element.

An attachment of this type of the tensioning element on the stack end element can be carried out particularly simply if the stack end element has at least one hooking nose for hooking the tensioning element.

It is also favourable if the tensioning element has at least one hooking opening for hooking onto the stack end element.

To generate the tensile stress in the tensioning element it may be provided that at least one tensioning element is fixed at least one of its end regions to another end region of the same tensioning element or to another tensioning element.

The tensioning element may thus be configured so as to be annularly closed, in particular.

The end region of at least one tensioning element may be connected positively, in particular, to another end region of the same tensioning element or to another tensioning element.

This connection may be configured, for example, as a crimp connection.

A particularly simple positive connection between two end regions of the same tensioning element or between end regions of different tensioning elements is achieved if at least one portion of an end region of at least one tensioning element is pressed through a through-opening in another end region of the same tensioning element or in another tensioning element and is subsequently deformed in such a way that the portion which has been pushed through can no longer return through the through-opening.

As an alternative or in addition to this, it may be provided that one end region of at least one tensioning element has at least one through-opening and that a portion of another end region of the same tensioning element or a portion of another tensioning element is pushed through this through-opening and is subsequently deformed in such a way that the portion which has been pushed through can no longer return through the through-opening.

Furthermore, to generate the necessary tensile stress in the tensioning element it may be provided that at least one region of at least one tensioning element is fixed by means of a fastening device to another end region of the same tensioning element or to another tensioning element.

In order to enable the flow of force between the fuel cell units, on the one hand, and the tensioning element, on the other hand, to be controlled still more precisely and to be able to make it more uniform, it is advantageous if the fuel cell stack comprises at least one resilient pressure transmission element.

A pressure transmission element of this type may, in particular, be arranged between a fuel cell unit and a stack end element, which forms an end face limitation of the fuel cell stack.

In order to be able to operate the fuel cell units at an operating temperature located clearly above the ambient temperature, in particular when using high-temperature fuel cell units, for example of the SOFC (Solid Oxide Fuel Cell) type, it is advantageous if the fuel cell stack comprises at least one heat insulation element.

A heat insulation element of this type may be arranged, in particular, between the fuel cell units and at least one tensioning element. In this case, it is necessary for the tensioning element to be mechanically and chemically resistant at the operating temperature of the fuel cell units.

It is particularly favourable for an introduction of force, which is uniform and over a large area, into the fuel cell units if the tensioning device comprises at least one tensioning element, which extends around both end faces of the fuel cell stack.

The tensioning element is preferably configured so as to be annularly closed in this case.

Further features and advantages of the invention are the subject of the following description and the view of the embodiments in the drawings, in which:

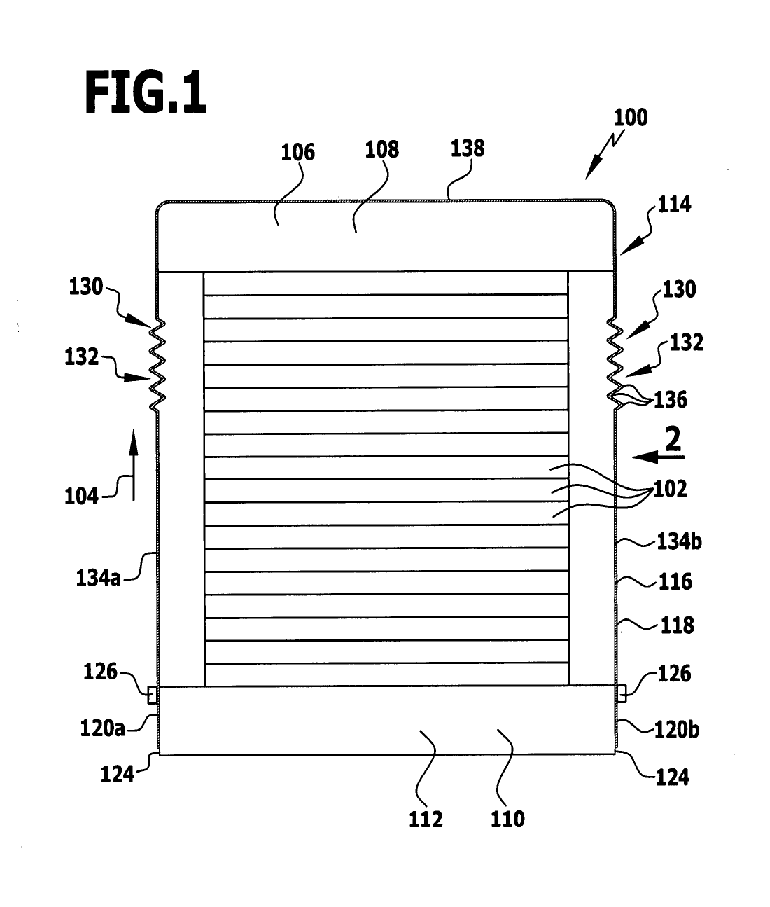

FIG. 1 shows a schematic front view of a fuel cell stack with two end plates and two tensioning tapes guided around one of the end plates, which tapes are hooked onto the second end plate;

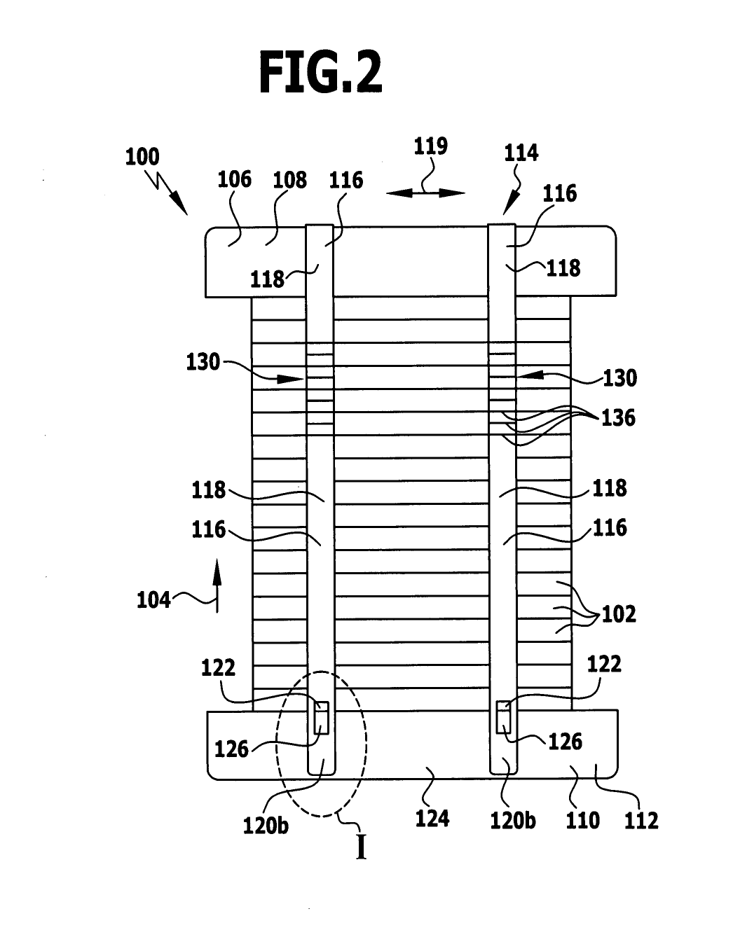

FIG. 2 shows a schematic side view of the fuel cell stack from FIG. 1 with the viewing direction in the direction of the arrow 2 in FIG. 1;

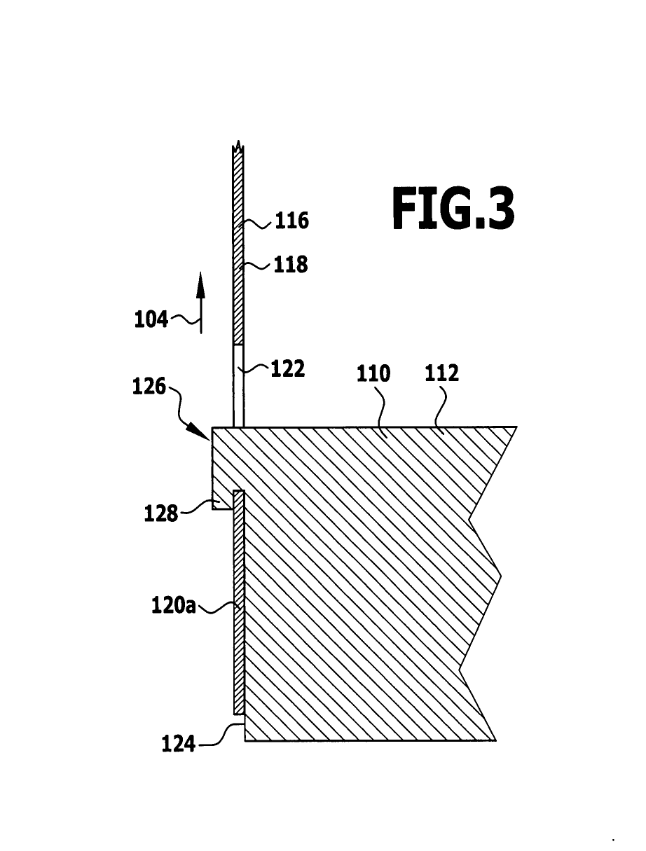

FIG. 3 shows a schematic vertical section through an edge region of the lower end plate of the fuel cell stack and a tensioning band hooked thereon;

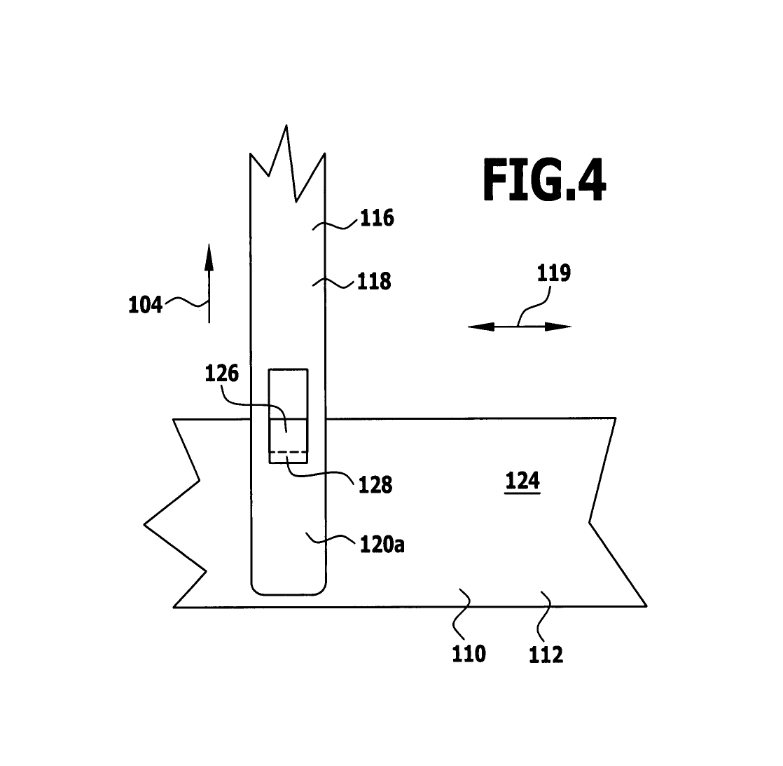

FIG. 4 shows an enlarged view of the region I from FIG. 2;

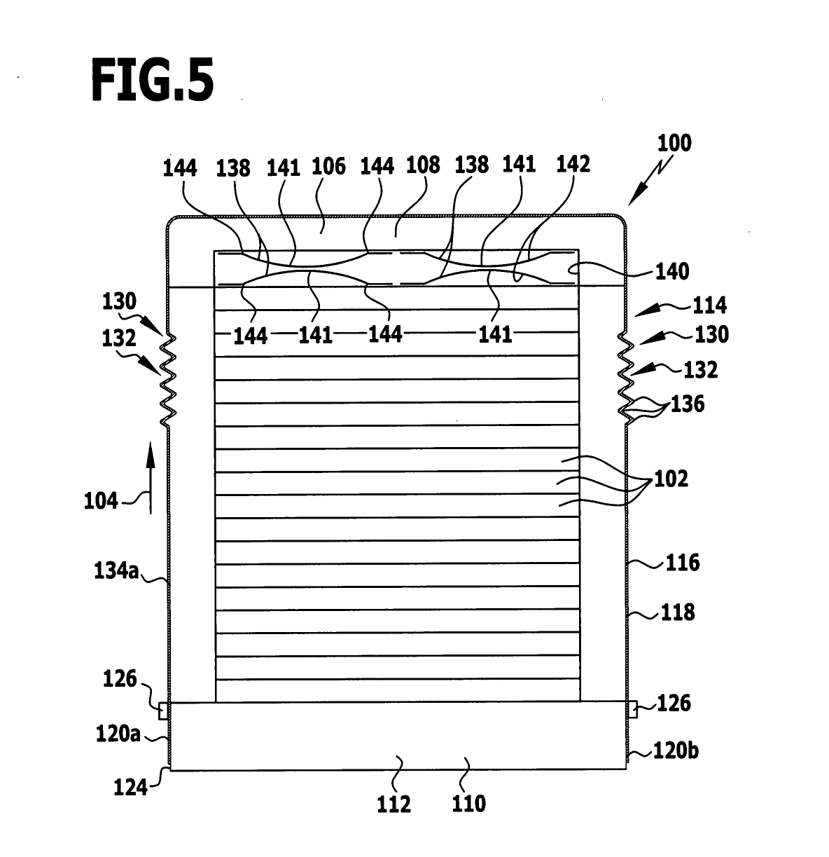

FIG. 5 shows a schematic front view of a second embodiment of a fuel cell stack, which comprises resilient pressure transmission elements arranged between the uppermost fuel cell unit and the upper end plate;

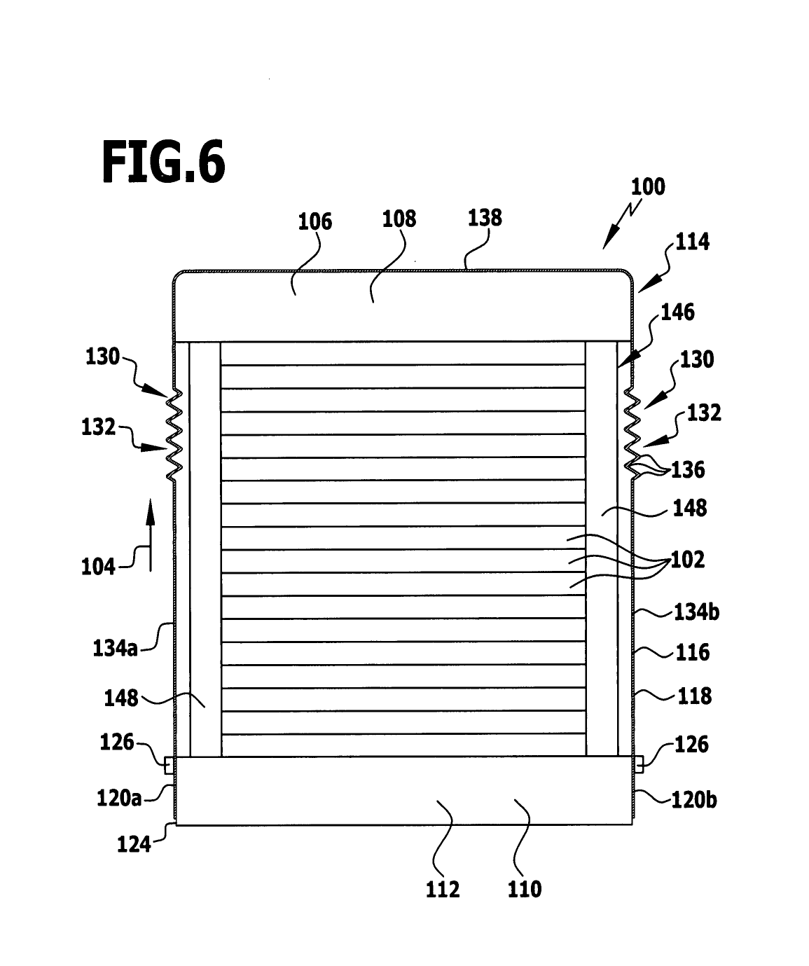

FIG. 6 shows a schematic front view of a third embodiment of a fuel cell stack, which comprises heat insulation elements surrounding the fuel cell units;

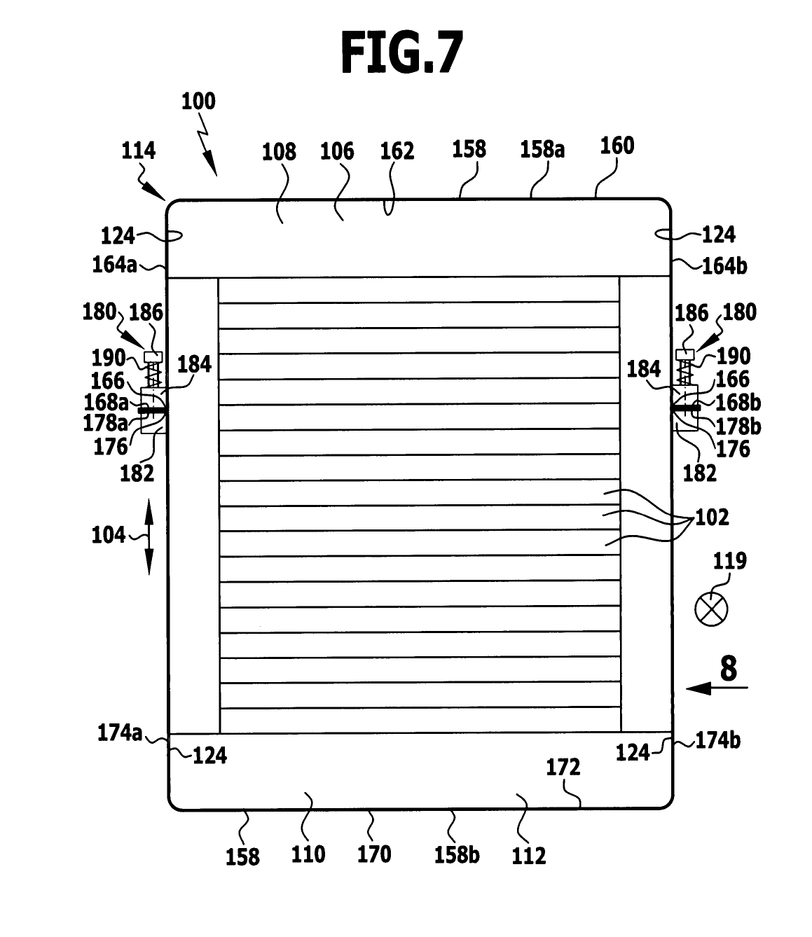

FIG. 7 shows a schematic front view of a fourth embodiment of a fuel cell stack, which comprises two tensioning strips, which extend, in each case, around an end plate of the fuel cell stack and are fixed to one another by means of a fastening device;

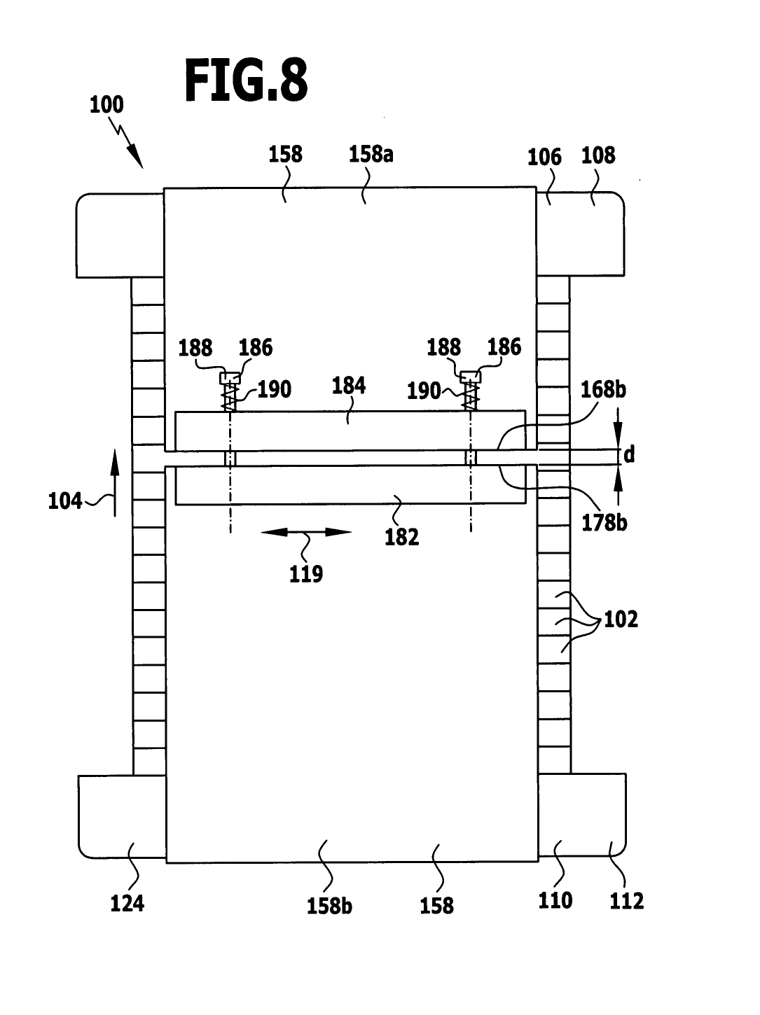

FIG. 8 shows a schematic side view of the fuel cell stack from FIG. 7, with the viewing direction in the direction of the arrow 8 in FIG. 7;

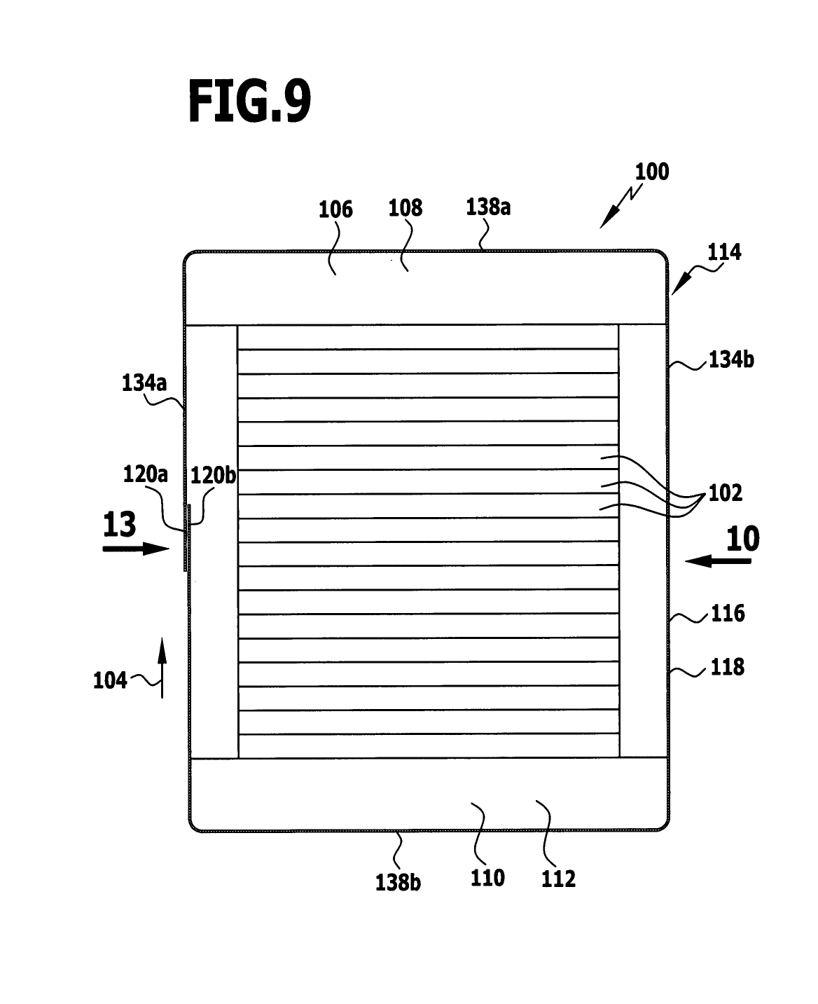

FIG. 9 shows a schematic front view of a fifth embodiment of a fuel cell stack, which comprises two tensioning tapes, which extend around the two end plates of the fuel cell stack, are fixed to themselves at their end regions and in each case have a resilient longitudinal expansion compensation element in the form of a region provided with a deformable recess;

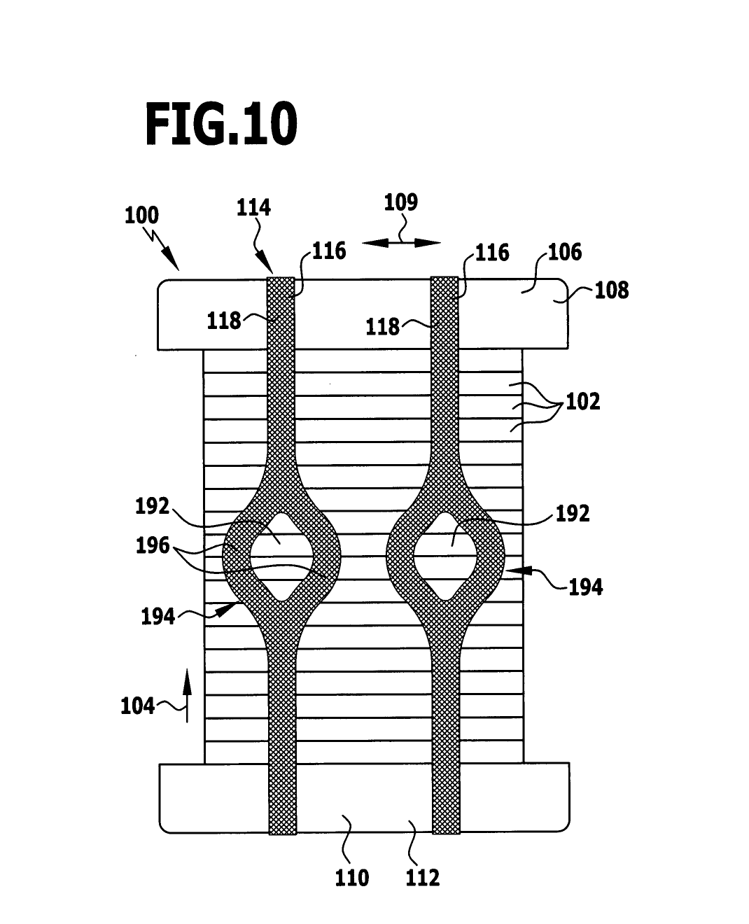

FIG. 10 shows a schematic side view of the fuel cell stack from FIG. 9, with the viewing direction in the direction of the arrow 10 in FIG. 9;

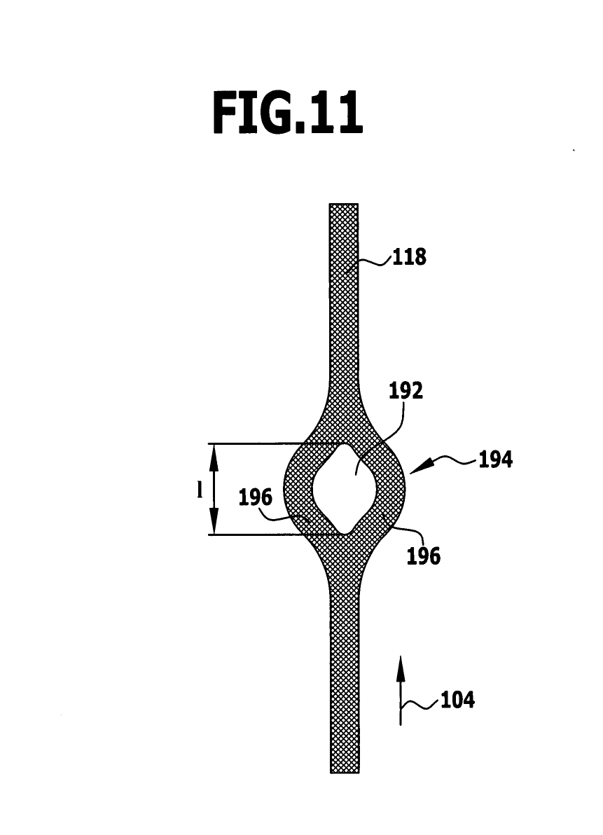

FIG. 11 shows a schematic plan view of the longitudinal expansion compensation region of one of the tensioning tapes in a non-expanded state;

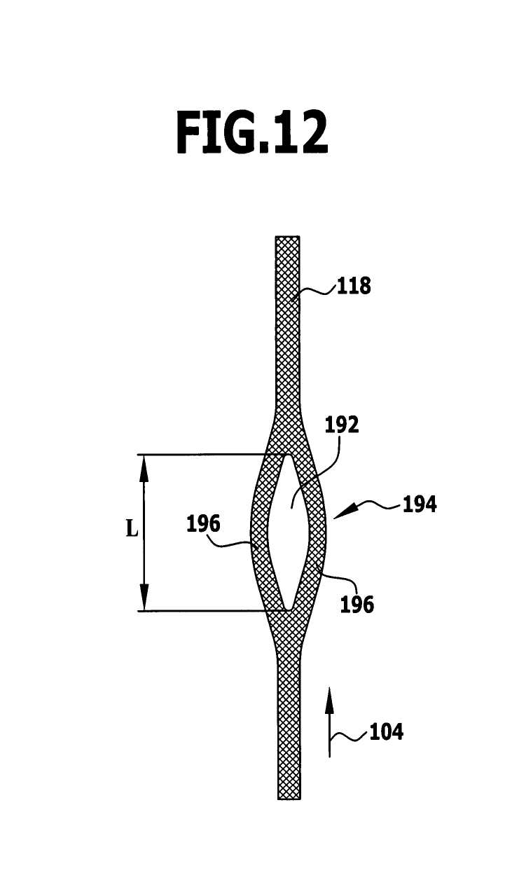

FIG. 12 shows a schematic plan view of the longitudinal expansion compensation region of one of the tensioning tapes in an expanded state;

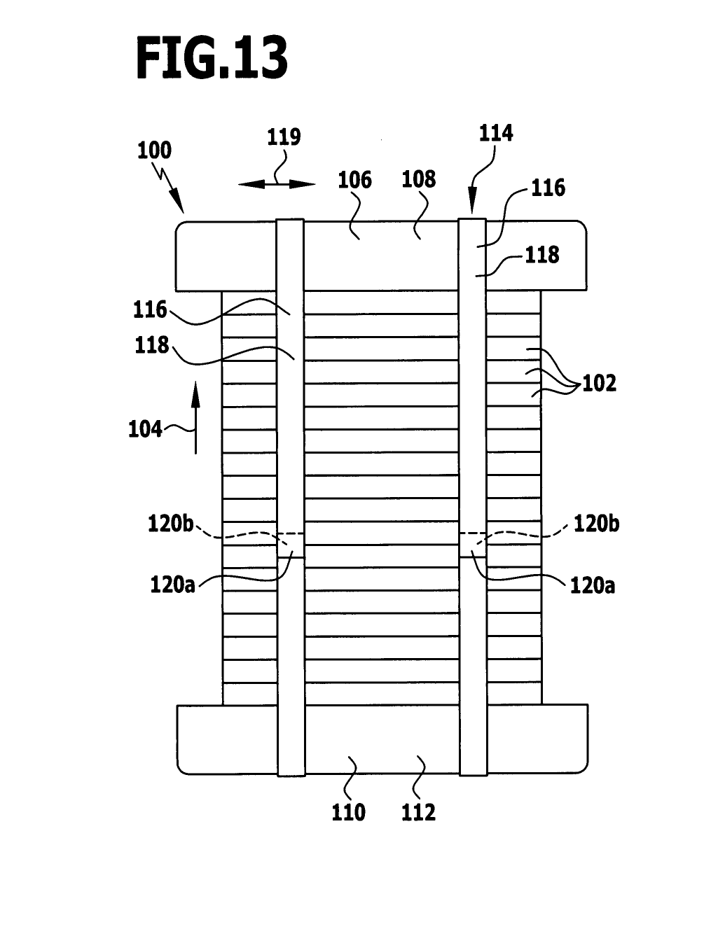

FIG. 13 shows a schematic side view of the fuel cell stack from FIG. 9, with the viewing direction in the direction of the arrow 13 in FIG. 9;

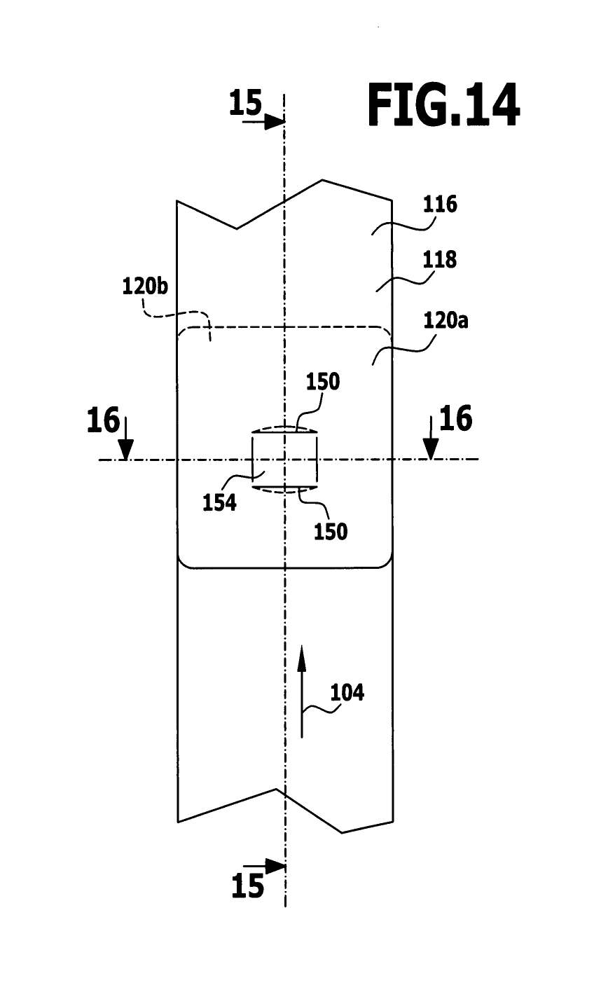

FIG. 14 shows a schematic plan view of the end regions of one of the tensioning tapes from FIG. 13;

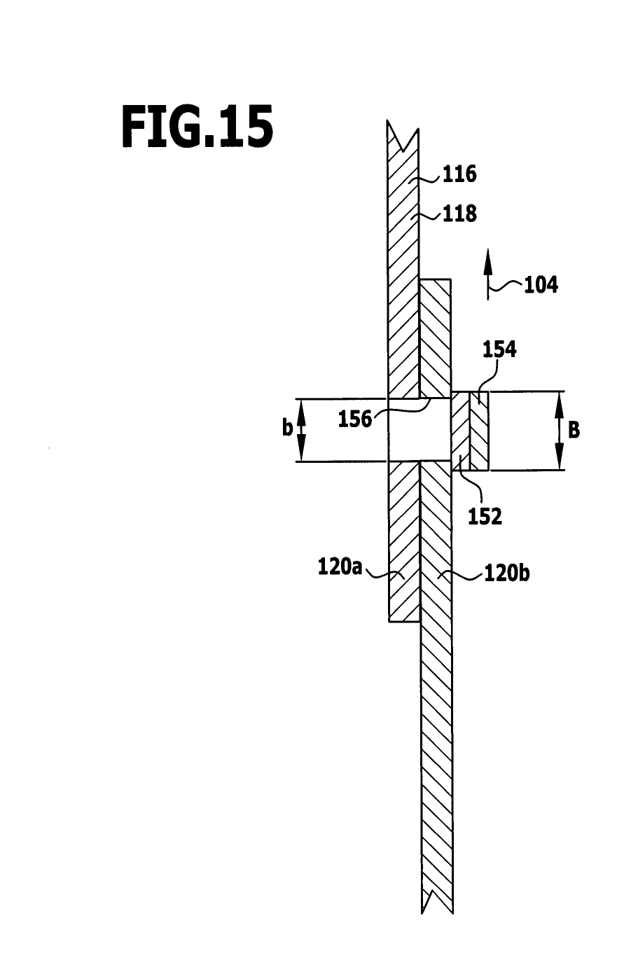

FIG. 15 shows a schematic vertical section through the end regions of the tensioning tape from FIG. 14, along the line 15-15 in FIG. 14; and

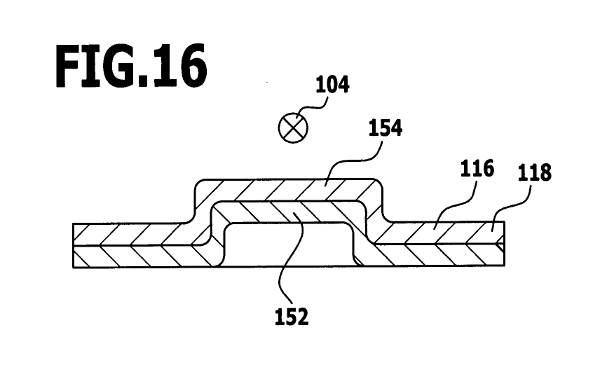

FIG. 16 shows a schematic horizontal section through the end regions of the tensioning tape from FIG. 14, along the line 16-16 in FIG. 14.

The same or functionally equivalent elements are designated with the same reference numerals in all the figures.

A fuel cell stack designated as a whole by 100, shown in FIGS. 1 to 4, comprises a plurality of planar fuel cell units 102, which are stacked on top of one another along a stack direction 104.

Each of the fuel cell units 102 comprises a housing (not shown in detail) which can be composed, for example, from a first sheet metal formed part configured as a housing upper part and a second sheet metal formed part configured as a housing lower part, as shown and described, for example in DE 100 44 703 A1.

Each of the fuel cell units 102 is provided with through-openings for fuel gas and with through-openings for an oxidation means, the through-openings along the stack direction 104 of consecutive fuel cell units 102 being aligned with one another in such a way that feed channels for fuel gas and for oxidation means penetrating the fuel cell stack 100 as well as discharge channels for excess fuel gas and excess oxidation means are formed.

A substrate with a cathode-electrolyte-anode unit (CEA unit) arranged thereon is held on the housing of each fuel cell unit 102, the electrochemical fuel cell reaction taking place in the CEA unit.

The CEA units of mutually adjacent fuel cell units 102 are connected to one another by means of electrically conductive contact elements.

The housings of consecutive fuel cell units 102 are connected to one another by means of electrically insulating, gas-tight sealing elements.

The upper end face of the fuel cell stack 100 is delimited by a first stack end element 106 in the form of an upper end plate 108.

The lower end face of the fuel cell stack 100 is delimited by a second stack end element 110 in the form of a lower end plate 112.

The end plates 108, 112, have a larger horizontal cross section than the fuel cell units 102 and project laterally over the fuel cell units 102 stacked on top of one another.

The end plates 108, 112 are preferably formed from a metallic material which is chemically and mechanically stable at the operating temperature of the fuel cell units 102 and may have gas through-channels connected to the feed channels and discharge channels for fuel gas oxidation means penetrating the fuel cell units 102.

In order to apply the required sealing forces to the sealing elements of the fuel cell units 102 and the required contact forces to the contact elements of the fuel cell units 102 during operation of the fuel cell stack 100, the fuel cell stack 100 also comprises a tensioning device 114, by means of which the stack end elements 106, 110, and therefore the fuel cell units 102 arranged therebetween, are braced against one another.

In the embodiment of a fuel cell stack 100 shown in FIGS. 1 to 4, this tensioning device 114 comprises a plurality of, for example two, tape-type tensioning elements 116 in form of tensioning bands 118, which extend around one of the stack end elements 106, 110, for example around the upper end plate 108, and are hooked by their end regions 120a, 120b on the other stack end element, in each case, in other words for example, on the lower end plate 112.

In order to allow this hooking, the tensioning bands 118 are provided in their end regions 120a, 120b, in each case, with a, for example rectangular, hooking opening 122, while the lower end plate 112 is provided on its side walls 124 with a plurality of hooking noses 126, which have a projection 128 projecting downwardly.

When assembling the tensioning bands 118 on the fuel cell stack 100, the end regions 120a, 120b of the tensioning bands are drawn downwardly to such an extent that the projections 128 of the hooking noses 126 of the lower end plate 112 can be moved through the hooking openings 122 of the tensioning bands 118 and, once they have been drawn back up owing to the inherent elasticity of the respective tensioning band 118, the lower edges of the hooking openings 122 come to rest behind the projections 128 forming an undercut in each case and are therefore secured by the projections 128 against a detachment from the lower end plate 112.

The connection between a tensioning band 118 and the lower end plate 112 can be released in a simple manner in that the end region 120a, 120b of the tensioning band 118 is drawn downwardly until the respective hooking opening 122 is aligned with the hooking nose 126 in such a way that the edge of the hooking opening 122 can be moved past the hooking nose 126 away from the side wall 124 of the lower end plate 112, to bring the tensioning band 118 out of engagement with the hooking nose 126.

The two tensioning bands 118 are spaced apart from one another in a horizontal transverse direction 119 extending perpendicularly to the stack direction 104.

The tensioning bands 118 are preferably formed from a metallic material, in particular from a steel sheet material.

As an alternative to this, other materials with an adequately high tensile strength and thermal stability may also be used, for example suitable plastics materials.

When the fuel cell stack 100 changes its temperature, in particular is brought to operating temperature, the fuel cell units 102 with the stack end elements 106 and 110, on the one hand, and the tensioning elements 116, on the other hand, can expand to a different extent along the stack direction 104 because of different mean coefficients of heat expansion. In order to compensate such different longitudinal expansions and nevertheless be able to generate an adequately high contact force or sealing force between the fuel cell units 102 by means of the tensioning device 114, each of the tensioning elements 116 in each case has two resilient longitudinal expansion compensation elements 130, which are integrated in the form of regions 132 which are folded concertina-fashion or corrugated, into the two portions 134a, 134b of the respective tensioning band 118 extending parallel to the stack direction 104.

When the fuel cell units 102 expand more strongly along the stack direction 104 than the material of the tensioning bands 118, the expansion of the folded or corrugated regions 132 increases along the stack direction 104 by an amount corresponding to the longitudinal expansion difference in that the apex lines 136 of the folded or corrugated region 132 move further apart.

Conversely, a shortening of the folded or corrugated region 132 is achieved along the stack direction 104, in that the apex lines 136 of the folded or corrugated region 132 move closer together.

Thus, by means of a reversible change in length of the longitudinal compensation elements 130, a difference in the heat expansion of the fuel cell units 102, on the one hand, and the material of the tensioning elements 116, on the other hand, can be compensated, an overexpansion of the tensioning elements 116 avoided and a desired tensioning force acting on the fuel cell units 102 can be maintained.

The portion 138 of each tensioning band 118 arranged between the portions 134a, 134b extending parallel to the stack direction 104 and resting in a planar manner on the side walls 124 of the upper end plate 108, rests in a planar manner on the upper side of the upper end plate 108, so the tensile force of the tensioning elements 116 can act over a large area and uniformly distributed on the upper end plate 108, thus ensuring a more uniform flow of force through the upper end plate 108 onto the fuel cell units 102.

A second embodiment of a fuel cell stack 100 shown in FIG. 5 differs from the above-described first embodiment in that the first stack end element 106, in other words the upper end plate 108 does not rest directly on the uppermost fuel cell unit 102, but indirectly by way of a plurality of resilient pressure transmission elements 138, which are arranged between the first stack end element 106 and the uppermost fuel cell unit 102.

To receive these pressure transmission elements 138, the upper end plate 108 of the fuel cell stack 100 is provided on its lower side with a substantially rectangular cuboidal recess 140.

The resilient pressure transmission elements 138, may be configured, in particular, as sheet metal plates, which are provided in each case with a full bead 141 and are arranged on top of one another in pairs in such a way that the bead crests 142 of the full beads 141 face one another and the bead feet 144 are supported on the upper end plate 108 or on the uppermost fuel cell unit 102.

By using additional resilient pressure transmission elements 138 of this type, the flow of force between the fuel cell units 102, on the one hand, and the tensioning elements 116 and the stack end element 106, on the other hand, can be controlled still more precisely and made more uniform.

Otherwise, the second embodiment of a fuel cell stack 100 shown in FIG. 5 coincides with respect to structure and function with the first embodiment shown in FIGS. 1 to 4, to the above description of which reference is made in this respect.

A third embodiment shown in FIG. 6 of a fuel cell stack 100 differs from the first embodiment shown in FIGS. 1 to 4 in that a heat insulation 146 is arranged between the fuel cell units 102 and the tensioning device 114 and comprises end plates 108, 112 formed from heat-insulating material or comprising heat-insulating inserts, as well as heat insulation elements 148 laterally covering the fuel cell units 102.

The heat insulation 146 is in a position to transmit forces from the tensioning elements 116 to the fuel cell units 102.

The heat insulation 146 also allows the fuel cell units 102 to be operated at an operating temperature clearly above the ambient temperature.

The third embodiment of a fuel cell stack 100 shown in FIG. 6 is therefore suitable, in particular, for use with high temperature fuel cell units, which have an operating temperature in the region of about 800° C. to about 950° C.

Such high-temperature fuel cell units may, in particular, be of the SOFC (Solid Oxide Fuel Cell) type.

Otherwise, the third embodiment of a fuel cell stack 100 shown in FIG. 6 coincides with regard to structure and function with the first embodiment shown in FIGS. 1 to 4, to the above description of which reference is made in this respect.

A fourth embodiment of a fuel cell stack 100 shown in FIGS. 7 and 8 differs from the first embodiment shown in FIGS. 1 to 4 in that the tensioning device 114, instead of the tensioning bands 118 provided in the first embodiment, comprises two strip-type tensioning elements 116 in the form of tensioning strips 158, which are preferably both configured as sheet metal strips.

As can be seen from FIGS. 7 and 8, an upper tensioning strip 158a extends around the upper end plate 108 and rests with a central portion 160 in a planar manner on the outer side 162 remote from the fuel cell units 102 and with two lateral portions 164a, 164b in a planar manner on the side walls 124 of the upper end plate 108.

The lateral portions 164a, 164b of the tensioning strip 158 pass, at their lower edge, in each case, along a bending line 166, in each case, into an end region 168a, 168b of the upper tensioning strip 158a oriented transversely to the stack direction 104.

A lower tensioning strip 158b extends around the lower end plate 112 and rests with a central portion 170 in a planar manner on the outer side 172 remote from the fuel cell units 102 and with two lateral portions 174a, 174b in a planar manner on the side walls 124 of the lower end plate 112.

The lateral portions 174a, 174b, at their upper edges along a respective bending line 176, in each case, pass into an end region 178a or 178b of the lower tensioning strip 158b oriented transversely to the stack direction 104.

The end regions 168a, 168b of the upper tensioning strip 158a and the end regions 178a, 178b of the lower tensioning strip 158b are fixed to one another by means of a fastening device 180, in each case, which comprises a fastening strip 182 extending in the transverse direction 119 and a receiving strip 184 extending parallel to the fastening strip 182 and a plurality of, for example two, fastening screws 186 spaced apart from one another in the transverse direction 119.

The fastening strip 182 rests with its upper side from below on the respectively associated end region 178a, 178b of the lower tensioning strip 158b and the receiving strip 184 rests with its lower side from above on the respectively associated end region 168a, 168b of the upper tensioning strip 158a.

The fastening screws 186 extend through through-openings in the receiving strip 184 and the end regions 168a, 178a or 168b, 178b and are screwed into threaded blind holes, which are provided in the fastening strip 182.

Arranged between the head 188 of each fastening screw 186 and the respectively associated receiving strip 184 is a spring element 190, in each case, in the form of a compression spring, which is supported on the head 188 and on the receiving strip 184, and biases the receiving strip 184 downwardly against the respectively associated end region 168a or 168b.

In the state shown in FIG. 7 of the fuel cell stack 100, the mutually opposing end regions 168a and 178a or 168b and 178b, of the two tensioning strips 158, rest on one another owing to this biasing by the spring element 190.

When, in the event of temperature change, the fuel cell units 102 with the stack end elements 106 and 110 expand more strongly along the stack direction 104 than the tensioning strips 158, the receiving strips 184 of the fastening devices 180 are moved away, against the restoring force of the spring elements 190 along the stack direction 104, from the fastening strips 182, so the end regions 168a and 178a or 168b and 178b are subsequently spaced apart from one another by the distance d, as shown in FIG. 8.

The spring elements 190 of the fastening devices 180 thus act as longitudinal expansion compensation elements, which compensate a difference d between the heat expansions of the fuel cell units 102 and the stack end elements 106, 110, on the one hand, and the tensioning strips 158 on the other hand.

Otherwise, the fourth embodiment of a fuel cell stack 100 shown in FIGS. 7 and 8 coincides with regard to structure and function with the first embodiment shown in FIGS. 1 to 4, to the description of which reference is made in this respect.

A fifth embodiment of a fuel cell stack 100 shown in FIGS. 9 to 16 differs from the first embodiment shown in FIGS. 1 to 4 in that the two strip-type tensioning elements 116 are not fixed to the lower end plate 112, but in each case extend around the two stack end elements 106, 110, the one end region 120a of each tensioning band 118 being connected to the other end region 120b of the same tensioning band 118 in such a way that each of the tensioning bands 118 forms an annularly closed tensioning element 116.

The two end regions 120a, 120b can be connected to one another, as shown in FIGS. 14 to 16, in particular in that a first portion 152 separated from the remaining first end region 120a by two slots 150 (extending, for example, perpendicularly to the stack direction 104) and a second portion 154 of the tensioning band 118 also separated from the remaining second end region 120b by slots extending transversely to the stack direction 104 and substantially congruent with the first portion are formed out of the plane of the first end region 120a or of the second end region 120b in such a way that the first portion 152 passes through the through-opening 156, which is produced by the forming of the second portion 154 out of the plane of the second end region 120b.

The first portion 152 and second portion 154 are then deformed by a stamping process in such a way that their width B in other words their expansion in the stack direction 104 exceeds the width b of the through-opening 156 in the second end region 120b, in other words the extension thereof in the stack direction 104, so the first portion 152 that is pushed through the through-opening 156 can no longer be moved back through the through-opening 156 back into the plane of the first end region 120a.

By fixing the two end regions 120a and 120b of each tensioning band 118 to one another, the desired tensile force is generated in the tensioning bands 118 and is transmitted by means of the end plates 108, 112 onto the fuel cell units 102 in order to load these with the desired sealing forces and contact forces.

The portions 138a and 138b of each tensioning band 118, arranged between the portions 134a, 134b extending parallel to the stack direction 104, rest in a planar manner on the outside of the upper end plate 108 or the lower end plate 112 remote from the fuel cell units 102, so a large-area and uniform introduction of force from the tensioning bands 118 onto the end plates 108, 112 is ensured.

In addition, in the fifth embodiment of a fuel cell stack 100 shown in FIGS. 9 to 16, the portions 134b of the tensioning bands 118 extending parallel to the stack direction 104 are provided with resilient longitudinal expansion compensation elements 130 in the form of regions 194 which are provided in each case with a deformable recess 192 and are integrated into the respective tensioning band 118.

The deformable recesses 192 may in this case, for example, have a substantially rhombic design.

The regions 194 of the tensioning bands 118 have a larger width than the portions of the tensioning bands 118 located outside these regions.

The regions 194 in each case have two webs 196, which bound the respective recess and may, for example, in each case have approximately the same width as the portions of the tensioning bands 118 located outside the regions 194.

In the starting state shown in FIG. 11, the deformable recess 192 has an extent I along the stack direction 104.

If the fuel cell units 102 with the stack elements 106 and 110, in the event of a temperature change, expand more strongly along the stack direction 104 than the material of the tensioning bands 118, the deformable recess 192 is expanded to a larger extent L along the stack direction 104, and the expansion of the region 194 increases accordingly along the stack direction 104.

In this manner it is therefore possible to compensate the different heat expansions of the fuel cell units 102 and the stack end elements 106, 110, on the one hand, and of the material of the tensioning bands 118, on the other hand.

On a return to the starting temperature, the region 194 with the deformable recess 192 deforms because of the inherent elasticity of the tensioning band 118 from the state shown in FIG. 12 back into the starting state shown in FIG. 11, so the desired tensile force in the tensioning bands 118 is also retained in the starting state shown in FIG. 11 and is transmitted by way of the stack end elements 106, 110 to the fuel cell units 102.

Otherwise, the fifth embodiment of a fuel cell stack 100 shown in FIGS. 9 to 16 coincides with regard to structure and function to the first embodiment shown in FIGS. 1 to 4, to the above description of which reference is made in this regard.

1. Fuel cell stack, comprising a plurality of fuel cell units that succeed one another along a stack direction and at least one tensioning device, by means of which the fuel cell units are braced against one another, wherein the tensioning device comprises at least one tensioning element, which transmits a tensile force for tensioning of the fuel cell units, and at least one resilient longitudinal expansion compensation element, which is integrated into a tensioning element or into a fastening device connecting two tensioning elements to one another.

2. Fuel cell stack according to claim 1, wherein at least one longitudinal expansion compensation element is formed by a corrugated and/or folded region of at least one tensioning element.

3. Fuel cell stack according to claim 1, wherein at least one longitudinal expansion compensation element is formed by a region, which is provided with a deformable recess, of at least one tensioning element.

4. Fuel cell stack according to claim 1, wherein the fastening device comprises at least one fastening means.

5. Fuel cell stack according to claim 4, wherein the fastening device comprises at least two fastening means which are spaced apart from one another in a direction extending transversely to the stack direction.

6. Fuel cell stack according to claim 4, wherein at least one fastening means is configured as a fastening screw.

7. Fuel cell stack according to claim 1, wherein the fastening device comprises at least one fastening strip, in which at least one fastening means engages.

8. Fuel cell stack according to claim 1, wherein the fastening device comprises at least one receiving strip, through which at least one fastening means extends.

9. Fuel cell stack according to claim 1, wherein the fastening device comprises at least one spring element, which biases an end region of at least one tensioning element against another end region of the same tensioning element or against an end region of another tensioning element.

10. Fuel cell stack according to claim 1, wherein at least one tensioning element is in the form of a strip or tape.

11. Fuel cell stack according to claim 1, wherein at least one tensioning element extends around at least one end face of the fuel cell stack.

12. Fuel cell stack according to claim 1, wherein the tensioning device comprises at least two tensioning elements, which extend around at least one end face of the fuel cell stack and are spaced apart from one another in a direction extending transversely to the stack direction.

13. Fuel cell stack according to claim 1, wherein the fuel cell stack comprises at least one stack end element, which forms an end face limitation of the fuel cell stack.

14. Fuel cell stack according to claim 13, wherein at least one stack end element is configured as an end plate.

15. Fuel cell stack according to claim 13, wherein at least one tensioning element extends around at least one stack end element of the fuel cell stack.

16. Fuel cell stack according to claim 15, wherein at least one tensioning element rests on at least one stack end element.

17. Fuel cell stack according to claim 16, wherein at least one tensioning element rests in substantially flat manner on at least one stack end element.

18. Fuel cell stack according to claim 13, wherein at least one tensioning element is fixed to at least one stack end element.

19. Fuel cell stack according to claim 18, wherein at least one tensioning element is fixed to at least one stack end element in cohesive manner.

20. Fuel cell stack according to claim 18, wherein at least one tensioning element is fixed by means of at least one fastening means, in particular by means of at least one screw, to at least one stack end element.

21. Fuel cell stack according to claim 13, wherein at least one tensioning element is fixed to at least one stack end element in releasable manner.

22. Fuel cell stack according to claim 13, wherein at least one tensioning element is hooked onto at least one stack end element.

23. Fuel cell stack according to claim 22, wherein at least one stack end element comprises at least one hooking nose for hooking on the at least one tensioning element.

24. Fuel cell stack according to claim 22, wherein at least one tensioning element comprises at least one hooking opening for hooking onto at least one stack end element.

25. Fuel cell stack according to claim 1, wherein at least one tensioning element is fixed at least one of its end regions to another end region of the same tensioning element or to another tensioning element.

26. Fuel cell stack according to claim 25, wherein at least one end region of at least one tensioning element is positively connected to another end region of the same tensioning element or to another tensioning element.

27. Fuel cell stack according to claim 25, wherein at least one portion of an end region of at least one tensioning element is pushed through a through-opening in another end region of the same tensioning element or in another tensioning element and is then deformed in such a way that the portion that has been pushed through can no longer return through the through-opening.

28. Fuel cell stack according to claim 25, wherein an end region of at least one tensioning element has at least one through-opening and wherein a portion of another end region of the same tensioning element or a portion of another tensioning element has been pushed through this through-opening and then deformed in such a way that the portion which has been pushed through can no longer return through the through-opening.

29. Fuel cell stack according to claim 25, wherein at least one end region of at least one tensioning element is fixed by means of a fastening device to another end region of the same tensioning element or to another tensioning element.

30. Fuel cell stack according to claim 1, wherein the fuel cell stack comprises at least one resilient pressure transmission element.

31. Fuel cell stack according to claim 30, wherein at least one pressure transmission element is arranged between a fuel cell unit and a stack end element, which forms an end face limitation of the fuel cell stack.

32. Fuel cell stack according to claim 1, wherein the fuel cell stack comprises at least one heat insulation element.

33. Fuel cell stack according to claim 32, wherein at least one heat insulation element is arranged between the fuel cell units and at least one tensioning element.

34. Fuel cell stack according to claim 1, wherein the tensioning element comprises at least one tensioning element, which extends around both end faces of the fuel cell stack.
